(19) United States
(12) Patent Application Publication
(10) Pub. No.: US 2026/0029637 A1
(43) Pub. Date: Jan. 29, 2026

(54) OBSERVATION OPTICAL SYSTEM AND OPTICAL APPARATUS

(71) Applicant: FUJIFILM Corporation, Tokyo (JP)

(72) Inventor: Shunsuke MIYAGISHIMA, Saitama (JP)

(73) Assignee: FUJIFILM Corporation, Tokyo (JP)

(21) Appl. No.: 19/268,441

(22) Filed: Jul. 14, 2025

(30) Foreign Application Priority Data
Jul. 26, 2024 (JP) 2024-121342

(51) Int. Cl. G02B 23/14; G02B 9/10; G02B 13/18

(52) U.S. Cl. CPC G02B 23/14; G02B 9/10; G02B 13/18

(57) ABSTRACT

An observation optical system consisting of, in order from an object side to an eyepoint side, two lenses including an objective lens having a negative refractive power and an eyepiece lens having a positive refractive power, wherein, in a case where: a paraxial curvature radius of a surface of the eyepiece lens on the eyepoint side is denoted by R4, a paraxial curvature radius of a surface of the objective lens on the eyepoint side is denoted by R2, Conditional Expressions (1) is satisfied: 1.7<(R4−R2)/(R4+R2)<4(1).

### CROSS-REFERENCE TO RELATED APPLICATIONS

This application claims priority from Japanese Application No. 2024-121342, filed on Jul. 26, 2024, the entire disclosure of which is incorporated herein by reference.

### BACKGROUND

### Technical Field

The disclosed technology relates to an observation optical system and an optical apparatus.

### Related Art

In the related art, optical systems according to JP2002-214542A, JP1998-282408A (JP-H10-282408A), JP1995-092387A (JP-H07-092387A), JP1994-230276A (JP-H06-230276A), JP1988-071822A (JP-S63-071822A), JP1986-091618A (JP-S61-091618A), and JP1977-062023A (JP-S52-062023A) have been known as finders of a camera or the like.

In recent years, there has been demand for an observation optical system that is reduced in size and has favorable optical performance.

### SUMMARY

The present disclosure provides an observation optical system that is reduced in size and has favorable optical performance, and an optical apparatus comprising the observation optical system.

An observation optical system according to an aspect of the present disclosure is an observation optical system consisting of, in order from an object side to an eyepoint side, two lenses including an objective lens having a negative refractive power and an eyepiece lens having a positive refractive power, in which, in a case where a paraxial curvature radius of a surface of the eyepiece lens on the eyepoint side is denoted by R4, a paraxial curvature radius of a surface of the objective lens on the eyepoint side is denoted by R2, a distance from an intersection between a surface of the objective lens on the object side and an optical axis to an intersection between the surface of the eyepiece lens on the eyepoint side and the optical axis is denoted by Dsum, a focal length of the objective lens is denoted by f1, a focal length of the eyepiece lens is denoted by f2, an average value of refractive indices of all lenses included in the observation optical system on a d line is denoted by Nave, and a center thickness of the eyepiece lens is denoted by D2,

Conditional Expressions (1), (2), (3), and (4) are satisfied, which are represented by

$$1.7 < ( R 4 - R 2 ) / ( R 4 + R 2 ) < 4 , \qquad ( 1 )$$

$$50 < Dsum / ( \vert f 1 \vert / f 2 ) < 80 , \qquad ( 2 )$$

$$1.45 < Nave < 1.65 , and \qquad ( 3 )$$

$$0.1 < D 2 / Dsum < 0.3 . \qquad ( 4 )$$

It is preferable that the surface of the objective lens on the eyepoint side includes a region that has a concave surface facing the eyepoint side in a paraxial region and has the negative refractive power which decreases away from the optical axis.

It is preferable that the surface of the eyepiece lens on the eyepoint side includes a region that has a convex surface facing the eyepoint side in a paraxial region and has the positive refractive power which increases away from the optical axis.

The observation optical system preferably satisfies Conditional Expression (1-1), further preferably satisfies Conditional Expression (1-2), and further preferably satisfies Conditional Expression (1-3).

$$1.8 < ( R 4 - R 2 ) / ( R 4 + R 2 ) < 3.5 \qquad ( 1 - 1 )$$

$$1.85 < ( R 4 - R 2 ) / ( R 4 + R 2 ) < 3 \qquad ( 1 - 2 )$$

$$1.9 < ( R 4 - R 2 ) / ( R 4 + R 2 ) < 2.7 \qquad ( 1 - 3 )$$

The observation optical system preferably satisfies Conditional Expression (2-1), further preferably satisfies Conditional Expression (2-2), and further preferably satisfies Conditional Expression (2-3).

$$55 < D sum / ( \vert f 1 \vert / f 2 ) < 78 \qquad ( 2 - 1 )$$

$$60 < D sum / ( \vert f 1 \vert / f 2 ) < 75 \qquad ( 2 - 2 )$$

$$61.5 < Dsum / ( \vert f 1 \vert / f 2 ) < 74 \qquad ( 2 - 3 )$$

The observation optical system preferably satisfies Conditional Expression (3-1), further preferably satisfies Conditional Expression (3-2), and further preferably satisfies Conditional Expression (3-3).

$$1.46 < Nave < 1.6 \qquad ( 3 - 1 )$$

$$1.47 < Nave < 1.58 \qquad ( 3 - 2 )$$

$$1.475 < Nave < 1.56 \qquad ( 3 - 3 )$$

The observation optical system preferably satisfies Conditional Expression (4-1), further preferably satisfies Conditional Expression (4-2), and further preferably satisfies Conditional Expression (4-3).

$$0.105 < D 2 / Dsum < 0.26 \qquad ( 4 - 1 )$$

$$0.11 < D 2 / Dsum < 0.24 \qquad ( 4 - 2 )$$

$$0.115 < D 2 / Dsum < 0.22 \qquad ( 4 - 3 )$$

In a case where a refractive index of the objective lens on the d line is denoted by N1, and an Abbe number of the objective lens based on the d line is denoted by ν1, the observation optical system preferably satisfies Conditional Expression (5) represented by

$$1. 8 < N 1 + 0.01 \times ν1 < 2.14 . \qquad ( 5 )$$

In a case where a refractive index of the eyepiece lens on the d line is denoted by N2, and an Abbe number of the eyepiece lens based on the d line is denoted by ν2, the observation optical system preferably satisfies Conditional Expression (6) represented by

$$1.8 < N 2 + 0.01 \times ν2 < 2.14 . \qquad ( 6 )$$

The observation optical system preferably satisfies Conditional Expression (7) represented by

$$1 < f 2 / Dsum < 2. \qquad ( 7 )$$

In a case where an air conversion length on the optical axis from the surface of the objective lens on the eyepoint side to a surface of the eyepiece lens on the object side is denoted by D12, the observation optical system preferably satisfies Conditional Expression (8) represented by

$$0.05 < R 2 / D 12 < 1. \qquad ( 8 )$$

An optical apparatus according to another aspect of the present disclosure comprises the observation optical system of the above aspect.

In the present specification, “consist of” or “consisting of” means that a lens substantially not having a refractive power, an optical element other than a lens, such as a stop, a filter, a cover glass, and a prism, a lens flange, a lens barrel, an imaging element, and the like may be included in addition to the illustrated constituents.

In the present specification, a “lens having a positive refractive power” is synonymous with a “positive lens”. A “lens having a negative refractive power” is synonymous with a “negative lens”. A compound aspherical lens (that is, a lens functioning as one aspherical lens as a whole, composed of a spherical lens and a film having an aspherical shape formed on the spherical lens in an integrated manner) is not regarded as a cemented lens and is treated as one lens. Unless otherwise specified, a sign of a refractive power, a curvature radius, and a surface shape related to a lens having an aspherical surface are considered to be in a paraxial region. For a sign of the curvature radius, a sign of the curvature radius of a surface having a shape having a convex surface facing the object side is positive, and a sign of the curvature radius of a surface having a shape having a convex surface facing the eyepoint side is negative.

The term “focal length” used in the conditional expressions means a paraxial focal length. Values used in the conditional expressions are values based on a d line in a state where diopter is −1 diopter. The “d line”, the “C line” and the “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, an observation optical system that is reduced in size and has favorable optical performance, and an optical apparatus comprising the observation optical system can be provided.

### BRIEF DESCRIPTION OF THE DRAWINGS

FIG. 1 is a cross-sectional view corresponding to an observation optical system of Example 1 and illustrating a configuration and luminous fluxes of an observation optical system according to one embodiment of the present disclosure.

FIG. 2 is each aberration diagram of the observation optical system of Example 1.

FIG. 3 is a cross-sectional view illustrating a configuration and luminous fluxes of an observation optical system of Example 2.

FIG. 4 is each aberration diagram of the observation optical system of Example 2.

FIG. 5 is a cross-sectional view illustrating a configuration and luminous fluxes of an observation optical system of Example 3.

FIG. 6 is each aberration diagram of the observation optical system of Example 3.

FIG. 7 is a perspective view of a rear surface side of an optical apparatus according to one embodiment.

### DETAILED DESCRIPTION

Hereinafter, an embodiment of the present disclosure will be described with reference to the drawings.

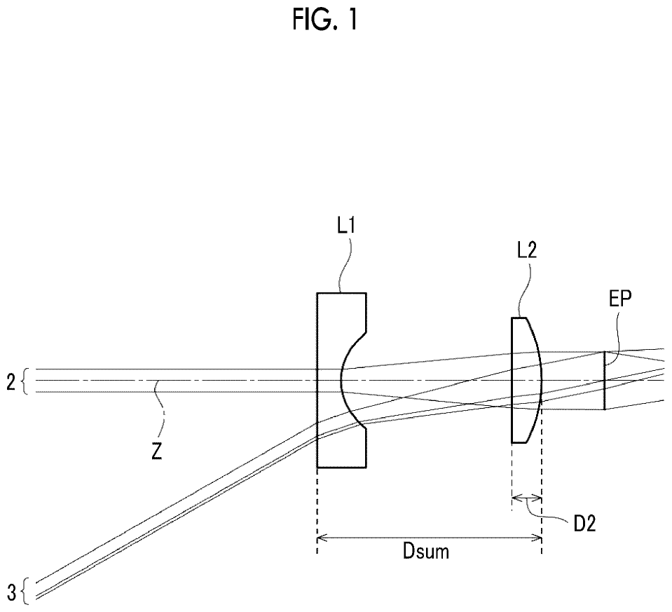

FIG. 1 illustrates a cross-sectional view of a configuration and luminous fluxes of an observation optical system according to one embodiment of the present disclosure. FIG. 1 illustrates an on-axis luminous flux 2 and an off-axis luminous flux 3 corresponding to a maximum apparent field of view as the luminous fluxes. FIG. 1 illustrates a left side as an object side and a right side as an eyepoint side. An eyepoint EP illustrated in FIG. 1 does not indicate a shape and indicates a position in an optical axis direction. The example illustrated in FIG. 1 corresponds to Example 1 (described later).

The observation optical system consists of, in order from the object side to the eyepoint side along an optical axis Z, two lenses including an objective lens L1 having a negative refractive power and an eyepiece lens L2 having a positive refractive power. Adopting such a configuration consisting of a negative lens and a positive lens in order from the object side to the eyepoint EP side achieves an advantage in reducing an optical total length and facilitates reduction in size.

A surface of the objective lens L1 on the eyepoint side preferably includes a region that has a concave surface facing the eyepoint side in a paraxial region and has the negative refractive power which decreases away from the optical axis Z. Doing so can reduce an increase in a distortion, and optical performance in a peripheral portion can be favorably maintained.

A surface of the objective lens L1 on the object side is preferably a plane. Doing so can improve incorporation into a mechanism frame.

A surface of the eyepiece lens L2 on the eyepoint side preferably includes a region that has a convex surface facing the eyepoint side in the paraxial region and has the positive refractive power which increases away from the optical axis Z. Doing so can reduce an increase in the distortion, and the optical performance in the peripheral portion can be favorably maintained.

A surface of the eyepiece lens L2 on the object side is preferably a plane. Doing so can improve incorporation into the mechanism frame.

Next, preferable configurations and available configurations related to conditional expressions of the observation optical system of the present disclosure will be described. In the following description related to the conditional expressions, in order to avoid redundancy, duplicate descriptions of symbols will be omitted using the same symbol for the same definition.

In a case where a paraxial curvature radius of the surface of the eyepiece lens L2 on the eyepoint side is denoted by R4, and a paraxial curvature radius of the surface of the objective lens L1 on the eyepoint side is denoted by R2, the observation optical system preferably satisfies Conditional Expression (1). Ensuring that a corresponding value of Conditional Expression (1) is not less than or equal to its lower limit value prevents an excessively low refractive power of the objective lens L1 and achieves an advantage in reduction in size in a radial direction. Ensuring that the corresponding value of Conditional Expression (1) is not greater than or equal to its upper limit value prevents an excessively low refractive power of the eyepiece lens L2 and achieves an advantage in correcting the distortion.

$$1.7 < ( R 4 - R 2 ) / ( R 4 + R 2 ) < 4 \qquad ( 1 )$$

In order to obtain more favorable characteristics, the lower limit value of Conditional Expression (1) is preferably set to any of 1.8, 1.85, 1.9, or 1.95. The upper limit value of Conditional Expression (1) is preferably set to any of 3.5, 3, 2.7, or 2.5. For example, the observation optical system preferably satisfies Conditional Expression (1-1), further preferably satisfies Conditional Expression (1-2), further preferably satisfies Conditional Expression (1-3), and further preferably satisfies Conditional Expression (1-4).

$$1.8 < ( R 4 - R 2 ) / ( R 4 + R 2 ) < 3.5 \qquad ( 1 - 1 )$$

$$1.85 < ( R 4 - R 2 ) / ( R 4 + R 2 ) < 3 \qquad ( 1 - 2 )$$

$$1.9 < ( R 4 - R 2 ) / ( R 4 + R 2 ) < 2.7 \qquad ( 1 - 3 )$$

$$1.95 < ( R 4 - R 2 ) / ( R 4 + R 2 ) < 2.5 \qquad ( 1 - 4 )$$

In a case where a distance from an intersection between the surface of the objective lens L1 on the object side and the optical axis Z to an intersection between the surface of the eyepiece lens L2 on the eyepoint side and the optical axis Z is denoted by Dsum, a focal length of the objective lens L1 is denoted by f1, and a focal length of the eyepiece lens L2 is denoted by f2, the observation optical system preferably satisfies Conditional Expression (2). Dsum is in millimeter (mm) units. Ensuring that a corresponding value of Conditional Expression (2) is not less than or equal to its lower limit value achieves an advantage in expanding the apparent field of view while favorably maintaining various aberrations. Ensuring that the corresponding value of Conditional Expression (2) is not greater than or equal to its upper limit value achieves an advantage in reducing the optical total length while maintaining the apparent field of view and facilitates reduction in size. For example, FIG. 1 illustrates Dsum in the observation optical system of FIG. 1 and D2 related to a conditional expression (described later).

$$50 < D sum / ( \vert f 1 \vert / f 2 ) < 80 \qquad ( 2 )$$

In order to obtain more favorable characteristics, the lower limit value of Conditional Expression (2) is preferably set to any of 55, 60, 61.5, or 62. The upper limit value of Conditional Expression (2) is preferably set to any of 78, 75, 74, or 73. For example, the observation optical system preferably satisfies Conditional Expression (2-1), further preferably satisfies Conditional Expression (2-2), further preferably satisfies Conditional Expression (2-3), and further preferably satisfies Conditional Expression (2-4).

$$55 < D sum / ( \vert f 1 \vert / f 2 ) < 78 \qquad ( 2 - 1 )$$

$$60 < D sum / ( \vert f 1 \vert / f 2 ) < 75 \qquad ( 2 - 2 )$$

$$61.5 < Dsum / ( \vert f 1 \vert / f 2 ) < 74 \qquad ( 2 - 3 )$$

$$62 < Dsum / ( \vert f 1 \vert / f 2 ) < 73 \qquad ( 2 - 4 )$$

In a case where an average value of refractive indices of all lenses included in the observation optical system on a d line is denoted by Nave, the observation optical system preferably satisfies Conditional Expression (3). Ensuring that a corresponding value of Conditional Expression (3) is not less than or equal to its lower limit value can reduce an increase in a Petzval sum and thus, achieves an advantage in correcting a field curvature. Ensuring that the corresponding value of Conditional Expression (3) is not greater than or equal to its upper limit value can prevent materials selectable as a lens material from being limited to those having a small Abbe number and thus, achieves an advantage in correcting a chromatic aberration.

$$1.45 < Nave < 1.65 \qquad ( 3 )$$

In order to obtain more favorable characteristics, the lower limit value of Conditional Expression (3) is preferably set to any of 1.46, 1.47, 1.475, or 1.48. The upper limit value of Conditional Expression (3) is preferably set to any of 1.6, 1.58, 1.56, or 1.54. For example, the observation optical system preferably satisfies Conditional Expression (3-1), further preferably satisfies Conditional Expression (3-2), further preferably satisfies Conditional Expression (3-3), and further preferably satisfies Conditional Expression (3-4).

$$1.46 < Nave < 1.6 \qquad ( 3 - 1 )$$

$$1.47 < Nave < 1.58 \qquad ( 3 - 2 )$$

$$1.475 < Nave < 1.56 \qquad ( 3 - 3 )$$

$$1.48 < Nave < 1.54 \qquad ( 3 - 4 )$$

In a case where a center thickness of the eyepiece lens L2 is denoted by D2, the observation optical system preferably satisfies Conditional Expression (4). Ensuring that a corresponding value of Conditional Expression (4) is not less than or equal to its lower limit value facilitates securing of an edge thickness of the eyepiece lens L2 (a thickness of the most peripheral part of the lens) and achieves an advantage in workability of the lens. Ensuring that the corresponding value of Conditional Expression (4) is not greater than or equal to its upper limit value prevents excessively small Dsum and thus, can reduce forming of a steep angle between a ray incident on the eyepiece lens L2 from the objective lens L1 and the optical axis Z. This achieves an advantage in reducing aberrations.

$$0.1 < D 2 / Dsum < 0.3 \qquad ( 4 )$$

In order to obtain more favorable characteristics, the lower limit value of Conditional Expression (4) is preferably set to any of 0.105, 0.11, 0.115, or 0.118. The upper limit value of Conditional Expression (4) is preferably set to any of 0.26, 0.24, 0.22, or 0.2. For example, the observation optical system preferably satisfies Conditional Expression (4-1), further preferably satisfies Conditional Expression (4-2), further preferably satisfies Conditional Expression (4-3), and further preferably satisfies Conditional Expression (4-4).

$$0.105 < D 2 / Dsum < 0.26 \qquad ( 4 - 1 )$$

$$0.11 < D 2 / Dsum < 0.24 \qquad ( 4 - 2 )$$

$$0.115 < D 2 / Dsum < 0.22 \qquad ( 4 - 3 )$$

$$0.118 < D 2 / Dsum < 0.2 \qquad ( 4 - 4 )$$

In a case where a refractive index of the objective lens L1 on a d line is denoted by N1, and an Abbe number of the objective lens L1 based on the d line is denoted by ν1, the observation optical system preferably satisfies Conditional Expression (5). Ensuring that a corresponding value of Conditional Expression (5) is not less than or equal to its lower limit value enables selection of a material other than a material having a low refractive index and a small Abbe number and thus, facilitates correction of a lateral chromatic aberration. Ensuring that the corresponding value of Conditional Expression (5) is not greater than or equal to its upper limit value enables selection of a material other than a material having a high refractive index and a large Abbe number and thus, enables selection of a material not having a high relative density and facilitates reduction in weight.

$$1.8 < N 1 + 0.01 \times v 1 < 2.14 \qquad ( 5 )$$

In order to obtain more favorable characteristics, the lower limit value of Conditional Expression (5) is preferably set to any of 1.85, 1.9, or 1.95. The upper limit value of Conditional Expression (5) is preferably set to any of 2.13, 2.12, or 2.11. For example, the observation optical system preferably satisfies Conditional Expression (5-1), further preferably satisfies Conditional Expression (5-2), and further preferably satisfies Conditional Expression (5-3).

$$1.85 < N 1 + 0.01 \times v 1 < 2.13 \qquad ( 5 - 1 )$$

$$1.9 < N 1 + 0.01 \times v 1 < 2.12 \qquad ( 5 - 2 )$$

$$1.95 < N 1 + 0.01 \times v 1 < 2.11 \qquad ( 5 - 3 )$$

In a case where a refractive index of the eyepiece lens L2 on a d line is denoted by N2, and an Abbe number of the eyepiece lens L2 based on the d line is denoted by ν2, the observation optical system preferably satisfies Conditional Expression (6). Ensuring that a corresponding value of Conditional Expression (6) is not less than or equal to its lower limit value enables selection of a material other than a material having a low refractive index and a small Abbe number and thus, facilitates correction of the lateral chromatic aberration. Ensuring that the corresponding value of Conditional Expression (6) is not greater than or equal to its upper limit value enables selection of a material other than a material having a high refractive index and a large Abbe number and thus, enables selection of a material not having a high relative density and facilitates reduction in weight.

$$1.8 < N 2 + 0.01 \times v 2 < 2.14 \qquad ( 6 )$$

In order to obtain more favorable characteristics, the lower limit value of Conditional Expression (6) is preferably set to any of 1.85, 1.9, or 1.95. The upper limit value of Conditional Expression (6) is preferably set to any of 2.13, 2.12, or 2.11. For example, the observation optical system preferably satisfies Conditional Expression (6-1), further preferably satisfies Conditional Expression (6-2), and further preferably satisfies Conditional Expression (6-3).

$$1.85 < N 2 + 0.01 \times v 2 < 2.13 \qquad ( 6 - 1 )$$

$$1.9 < N 2 + 0.01 \times v 2 < 2.12 \qquad ( 6 - 2 )$$

$$1.95 < N 2 + 0.01 \times v 2 < 2.11 \qquad ( 6 - 3 )$$

The observation optical system preferably satisfies Conditional Expression (7). Ensuring that a corresponding value of Conditional Expression (7) is not less than or equal to its lower limit value can reduce an excessive decrease in a finder magnification. Ensuring that the corresponding value of Conditional Expression (7) is not greater than or equal to its upper limit value prevents excessively small Dsum and thus, facilitates correction of various aberrations.

$$1 < f 2 / Dsum < 2 \qquad ( 7 )$$

In order to obtain more favorable characteristics, the lower limit value of Conditional Expression (7) is preferably set to any of 1.1, 1.2, or 1.3. The upper limit value of Conditional Expression (7) is preferably set to any of 1.8, 1.7, or 1.6. For example, the observation optical system preferably satisfies Conditional Expression (7-1), further preferably satisfies Conditional Expression (7-2), and further preferably satisfies Conditional Expression (7-3).

$$1.1 < f 2 / Dsum < 1.8 \qquad ( 7 - 1 )$$

$$1.2 < f 2 / Dsum < 1.7 \qquad ( 7 - 2 )$$

$$1.3 < f 2 / Dsum < 1.6 \qquad ( 7 - 3 )$$

In a case where an air conversion length on the optical axis Z from the surface of the objective lens L1 on the eyepoint side to the surface of the eyepiece lens L2 on the object side is denoted by D12, the observation optical system preferably satisfies Conditional Expression (8). Ensuring that a corresponding value of Conditional Expression (8) is not less than or equal to its lower limit value can reduce an increase in the optical total length. Ensuring that the corresponding value of Conditional Expression (8) is not greater than or equal to its upper limit value can reduce an excessive increase in a negative distortion.

$$0.05 < R 2 / D 12 < 1 \qquad ( 8 )$$

In order to obtain more favorable characteristics, the lower limit value of Conditional Expression (8) is preferably set to any of 0.15, 0.2, or 0.25. The upper limit value of Conditional Expression (8) is preferably set to any of 0.8, 0.6, or 0.5. For example, the observation optical system preferably satisfies Conditional Expression (8-1), further preferably satisfies Conditional Expression (8-2), and further preferably satisfies Conditional Expression (8-3).

$$0.15 < R 2 / D 12 < 0.8 \qquad ( 8 - 1 )$$

$$0.2 < R 2 / D 12 < 0.6 \qquad ( 8 - 2 )$$

$$0.25 < R 2 / D 12 < 0.5 \qquad ( 8 - 3 )$$

The above preferable configurations and available configurations including the configurations related to the conditional expressions can be used in any combination thereof and are preferably selectively adopted, as appropriate, in accordance with required specifications. The example of FIG. 1 is merely an example, and various modifications can be made without departing from the gist of the disclosed technology.

For example, according to a preferable aspect of the observation optical system of the present disclosure, an observation optical system consists of, in order from the object side to the eyepoint side, two lenses including the objective lens L1 having a negative refractive power and the eyepiece lens L2 having a positive refractive power, in which Conditional Expressions (1), (2), (3), and (4) are satisfied.

Next, examples of the observation optical system of the present disclosure will be described with reference to the drawings. Reference numerals assigned to the components of the observation optical system in the cross-sectional view of each example are independently used for each example in order to avoid complication of description and illustration caused by an increase in the number of digits of the reference numerals. Accordingly, a common reference numeral assigned in the drawings of different examples does not necessarily indicate a common configuration.

### Example 1

A cross-sectional view of a configuration and luminous fluxes of the observation optical system of Example 1 is illustrated in FIG. 1, and its illustration method and configuration are the same as described above. Thus, duplicate descriptions will be partially omitted. The observation optical system of Example 1 consists of, in order from the object side to the eyepoint side, two lenses including the objective lens L1 having a negative refractive power and the eyepiece lens L2 having a positive refractive power. The surface of the objective lens L1 on the eyepoint side is an aspherical surface including a region that has a concave surface facing the eyepoint side in the paraxial region and has the negative refractive power which decreases away from the optical axis Z. The surface of the objective lens L1 on the object side is a plane. The surface of the eyepiece lens L2 on the eyepoint side is an aspherical surface including a region that has a convex surface facing the eyepoint side in the paraxial region and has the positive refractive power which increases away from the optical axis Z. The surface of the eyepiece lens L2 on the object side is a plane.

For the observation optical system of Example 1, Table 1 shows basic lens data, and Table 2 shows aspherical coefficients.

The table of the basic lens data is described as follows. A column of Sn shows surface numbers in a case where a surface closest to the object side is referred to as a first surface, and the number is increased by one for each surface to the eyepoint side. A column of R shows a curvature radius of each surface. A column of D shows a surface spacing on the optical axis between each surface and a surface adjacent thereto on the eyepoint side. A column of Nd shows a refractive index of each constituent with respect to a d line. A column of vd shows an Abbe number of each constituent based on the d line. A column of ER shows an effective radius of each lens surface.

In the table of the basic lens data, a sign of the curvature radius of a surface having a shape having a convex surface facing the object side is positive, and a sign of the curvature radius of a surface having a shape having a convex surface facing the eyepoint side is negative. A value in the lowest cell of the column of D in the table is a spacing between the surface closest to the eyepoint side in the table and the eyepoint EP. A value of a field of view angle with a full angle of view in a state where diopter is −1 diopter is shown outside the cells of the table of the basic lens data. The value of the field of view angle corresponds to a value of the apparent field of view.

In the basic lens data, the surface number of an aspherical surface is marked with *, and a field of the curvature radius of the aspherical surface shows a value of a paraxial curvature radius. In Table 2, a row of Sn shows the surface number of the aspherical surface, and rows of KA and Am (m=4, 6, 8, and 10) show numerical values of the aspherical coefficients for each aspherical surface. In the numerical values of the aspherical coefficients, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where
Zd: a depth of the aspherical surface (a length of a perpendicular line drawn from a point on the aspherical surface having a height h to a plane that is in contact with an aspherical surface apex and perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter (mm) unit is used for lengths. However, since the optical system can also be proportionally enlarged or proportionally reduced to be used, other appropriate units can also be used. Each table below shows numerical values rounded in a predetermined number of digits.

TABLE 1
Example 1

| Sn | R | D | Nd | νd | ER |
|---|---|---|---|---|---|
| 1 | ∞ | 2.5516 | 1.49100 | 57.58 | 7.24 |
| *2 | 6.7051 | 19.0000 | | | 5.50 |
| 3 | ∞ | 3.2984 | 1.49100 | 57.58 | 4.66 |
| *4 | −17.7477 | 7.0000 | | | 4.78 |

| | |
|---|---|
| Field of View Angle | 25.3 |
| (Degree) | |

TABLE 2
Example 1

| Sn | 2 | 4 |
|---|---|---|
| KA | −3.8438604E−01 | 1.4015812E+00 |
| A4 | 1.3852123E−04 | 0.0000000E+00 |
| A6 | 1.9546215E−05 | 0.0000000E+00 |
| A8 | −7.2198010E−07 | 0.0000000E+00 |
| A10 | 1.0745062E−08 | 0.0000000E+00 |

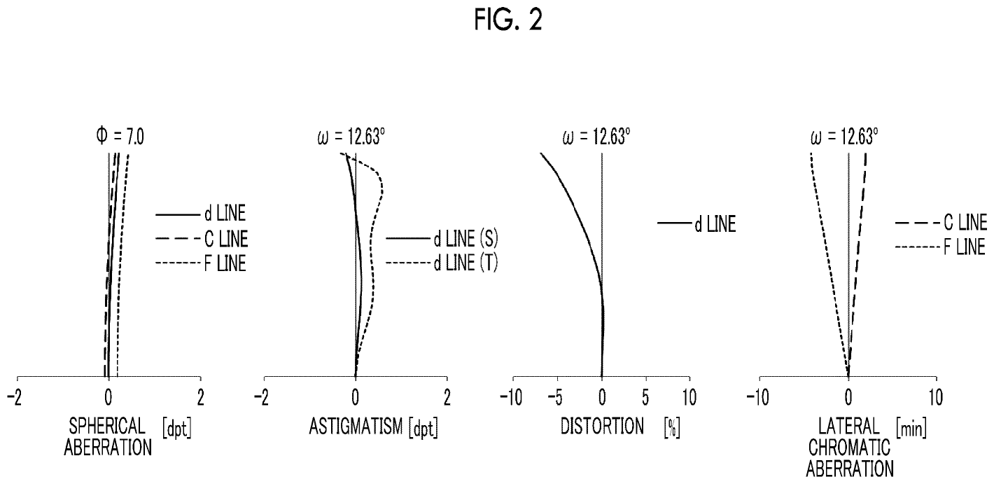

FIG. 2 illustrates each aberration diagram of the observation optical system of Example 1 in the state where the diopter is −1 diopter. FIG. 2 illustrates, in order from the left, a spherical aberration, an astigmatism, a distortion, and a lateral chromatic aberration. The spherical aberration diagram illustrates aberrations on a d line, a C line, and an F line with a solid line, a long broken line, and a short broken line, respectively. The astigmatism diagram illustrates an aberration on the d line in a sagittal direction with a solid line and illustrates an aberration on the d line in a tangential direction with a short broken line. The distortion diagram illustrates an aberration on the d line with a solid line. The lateral chromatic aberration diagram illustrates aberrations on the C line and the F line with a long broken line and a short broken line, respectively. A unit dpt on horizontal axes of the spherical aberration diagram and the astigmatism diagram denotes diopter. A unit min on a horizontal axis of the lateral chromatic aberration diagram denotes a minute of angle. The spherical aberration diagram illustrates a diameter of the eyepoint EP in millimeter (mm) units after “Φ=”. Other aberration diagrams illustrate the value of the apparent field of view with a half angle of view after “ω=”.

Unless otherwise specified, symbols, meanings, description methods, and illustration methods of each data related to Example 1 are the same as those in the following examples. Thus, duplicate descriptions will be omitted below.

### Example 2

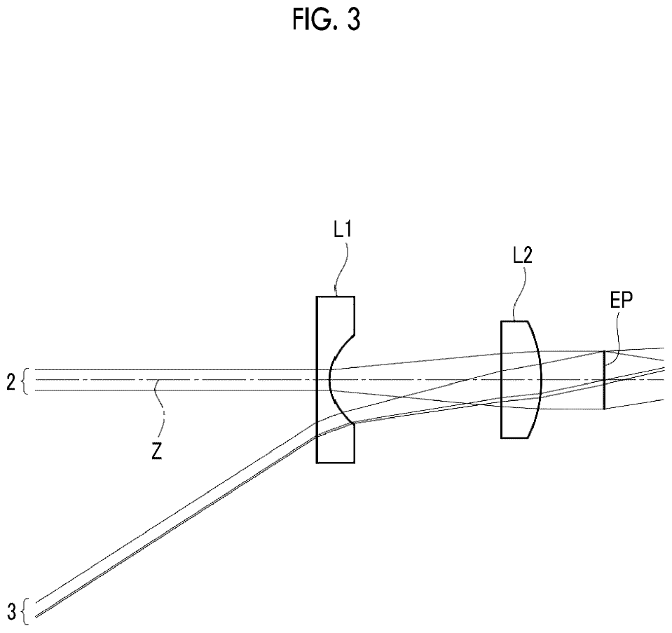

FIG. 3 illustrates a cross-sectional view of a configuration and luminous fluxes of an observation optical system of Example 2. The observation optical system of Example 2 consists of, in order from the object side to the eyepoint side, two lenses including the objective lens L1 having a negative refractive power and the eyepiece lens L2 having a positive refractive power. The surface of the objective lens L1 on the eyepoint side is an aspherical surface including a region that has a concave surface facing the eyepoint side in the paraxial region and has the negative refractive power which decreases away from the optical axis Z. The surface of the objective lens L1 on the object side is a plane. The surface of the eyepiece lens L2 on the eyepoint side is an aspherical surface including a region that has a convex surface facing the eyepoint side in the paraxial region and has the positive refractive power which increases away from the optical axis Z. The surface of the eyepiece lens L2 on the object side is a plane.

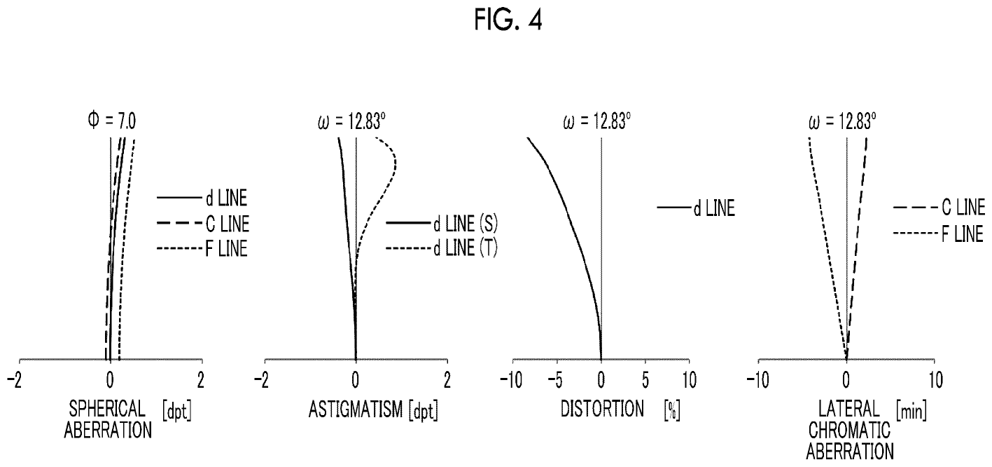

For the observation optical system of Example 2, Table 3 shows basic lens data, Table 4 shows aspherical coefficients, and FIG. 4 illustrates each aberration diagram in the state where the diopter is −1 diopter.

TABLE 3
Example 2

| Sn | R | D | Nd | νd | ER |
|---|---|---|---|---|---|
| 1 | ∞ | 1.4000 | 1.49100 | 57.58 | 6.96 |
| *2 | 6.0159 | 19.0000 | | | 5.40 |
| 3 | ∞ | 4.4516 | 1.49100 | 57.58 | 5.13 |
| *4 | −17.4140 | 7.0000 | | | 5.09 |

| | |
|---|---|
| Field of View Angle | 25.7 |
| (Degree) | |

TABLE 4
Example 2

| Sn | 2 | 4 |
|---|---|---|
| KA | 2.4143586E−01 | 1.6405367E+00 |
| A4 | 1.4546993E−04 | 0.0000000E+00 |
| A6 | 3.1264952E−06 | 0.0000000E+00 |
| A8 | −2.4383249E−07 | 0.0000000E+00 |
| A10 | 5.1861288E−09 | 0.0000000E+00 |

### Example 3

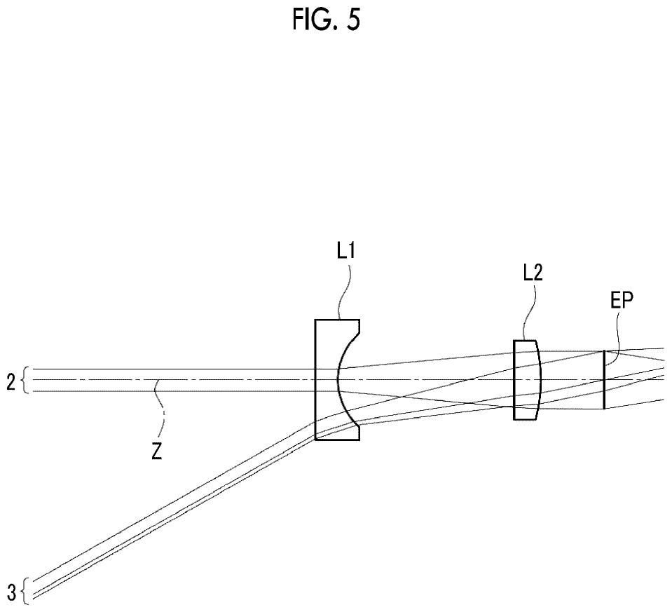

FIG. 5 illustrates a cross-sectional view of a configuration and luminous fluxes of an observation optical system of Example 3. The observation optical system of Example 3 consists of, in order from the object side to the eyepoint side, two lenses including the objective lens L1 having a negative refractive power and the eyepiece lens L2 having a positive refractive power. The surface of the objective lens L1 on the eyepoint side is an aspherical surface including a region that has a concave surface facing the eyepoint side in the paraxial region and has the negative refractive power which decreases away from the optical axis Z. The surface of the objective lens L1 on the object side is a plane. The surface of the eyepiece lens L2 on the eyepoint side is an aspherical surface including a region that has a convex surface facing the eyepoint side in the paraxial region and has the positive refractive power which increases away from the optical axis Z. The surface of the eyepiece lens L2 on the object side is a plane.

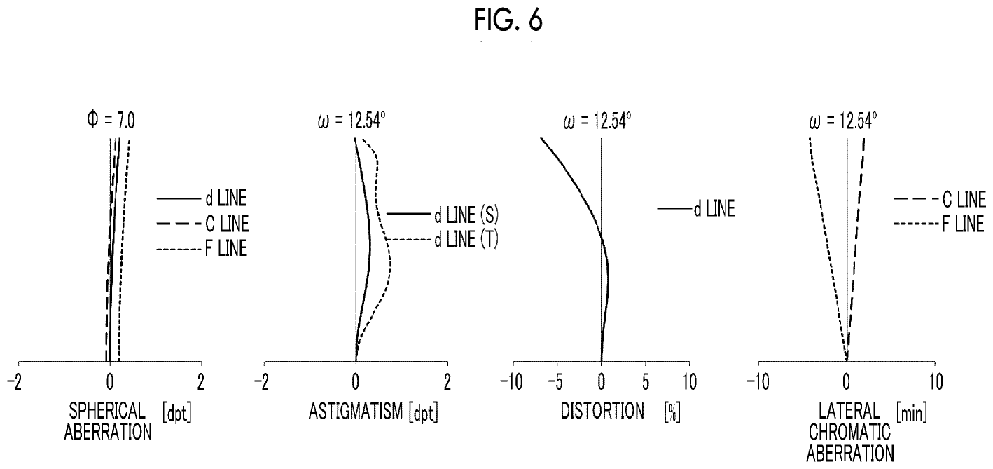

For the observation optical system of Example 3, Table 5 shows basic lens data, Table 6 shows aspherical coefficients, and FIG. 6 illustrates each aberration diagram in the state where the diopter is −1 diopter.

TABLE 5
Example 3

| Sn | R | D | Nd | νd | ER |
|---|---|---|---|---|---|
| 1 | ∞ | 2.3703 | 1.53480 | 55.73 | 7.23 |
| *2 | 7.2804 | 19.5177 | | | 5.65 |
| 3 | ∞ | 2.9616 | 1.53480 | 55.73 | 4.66 |
| *4 | −19.4394 | 7.0000 | | | 4.76 |

| | |
|---|---|
| Field of View Angle | 25.1 |
| (Degree) | |

TABLE 6
Example 3

| Sn | 2 | 4 |
|---|---|---|
| KA | −3.6789161E−01 | 1.3046748E+00 |
| A4 | −5.5068452E−05 | 0.0000000E+00 |
| A6 | 2.2321132E−05 | 0.0000000E+00 |
| A8 | −6.3997811E−07 | 0.0000000E+00 |
| A10 | 7.6204201E−09 | 0.0000000E+00 |

Table 7 shows the corresponding values of Conditional Expressions (1) to (8) of the observation optical systems of Examples 1 to 3. The values shown in Table 7 are values based on a d line.

TABLE 7

| Expression | Conditional | Exam- | Exam- | Exam- |
|---|---|---|---|---|
| Number | Expression | ple 1 | ple 2 | ple 3 |
| (1) | (R4 − R2)/(R4 + R2) | 2.4339 | 2.0556 | 2.1975 |
| (2) | Dsum/(\|f1\|/f2) | 65.7752 | 71.9371 | 66.3507 |
| (3) | Nave | 1.49100 | 1.49100 | 1.53480 |
| (4) | D2/Dsum | 0.1327 | 0.1791 | 0.1192 |
| (5) | N1 + 0.01 × ν1 | 2.06680 | 2.06680 | 2.09210 |
| (6) | N2 + 0.01 × ν2 | 2.06680 | 2.06680 | 2.09210 |
| (7) | f2/Dsum | 1.4546 | 1.4271 | 1.4628 |
| (8) | R2/D12 | 0.3529 | 0.3166 | 0.3730 |

The observation optical systems of Examples 1 to 3 implement high optical performance by favorably correcting various aberrations while being configured to be reduced in size.

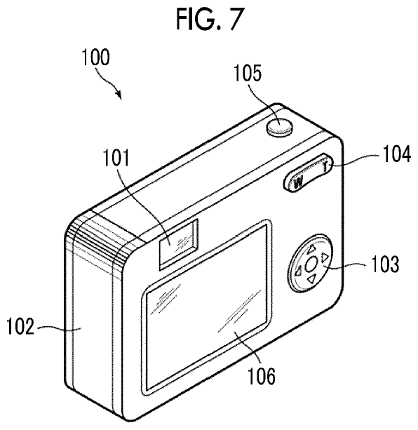

Next, an optical apparatus comprising the observation optical system according to the embodiment of the present disclosure will be described. FIG. 7 is a perspective view illustrating a schematic configuration of a rear surface side of a camera 100 that is the optical apparatus according to one embodiment of the present disclosure. For example, the camera 100 is a digital camera. The camera 100 comprises a finder 101 according to one embodiment of the present disclosure in an upper portion of a camera body 102. The finder 101 is an example of an observation optical apparatus and comprises the observation optical system according to one embodiment of the present disclosure.

The camera 100 comprises an operation button 103 for various settings, a zoom lever 104 for changing magnification, and a monitor 106 for displaying images and various setting screens, on a rear surface of the camera body 102 and comprises a shutter button 105 on an upper surface of the camera body 102. The camera 100 comprises an imaging lens (not illustrated) on a front surface of the camera body 102 and comprises an imaging element (not illustrated) that captures a subject image formed by the imaging lens, in the camera body 102. A user observes the subject image from the rear surface side through the finder 101.

While the disclosed technology has been described above with the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in the examples and may have other values.

The optical apparatus according to the embodiment of the present disclosure is also not limited to the above configuration and can also be applied to, for example, a film camera, a video camera, and a head-mounted display.

The following appendices are further disclosed with respect to the embodiment and the examples described above.

### Appendix 1

An observation optical system consisting of, in order from an object side to an eyepoint side, two lenses including an objective lens having a negative refractive power and an eyepiece lens having a positive refractive power,
in which, in a case where a paraxial curvature radius of a surface of the eyepiece lens on the eyepoint side is denoted by R4,
a paraxial curvature radius of a surface of the objective lens on the eyepoint side is denoted by R2,
a distance from an intersection between a surface of the objective lens on the object side and an optical axis to an intersection between the surface of the eyepiece lens on the eyepoint side and the optical axis is denoted by Dsum,
a focal length of the objective lens is denoted by f1,
a focal length of the eyepiece lens is denoted by f2,
an average value of refractive indices of all lenses included in the observation optical system on a d line is denoted by Nave, and
a center thickness of the eyepiece lens is denoted by D2,
Conditional Expressions (1), (2), (3), and (4) are satisfied, which are represented by

$$1.7 < ( R 4 - R 2 ) / ( R 4 + R 2 ) < 4 , \qquad ( 1 )$$

$$50 < Dsum / ( \vert f 1 \vert / f 2 ) < 80 , \qquad ( 2 )$$

$$1.45 < Nave < 1.65 , and \qquad ( 3 )$$

$$0.1 < D 2 / Dsum < 0.3 . \qquad ( 4 )$$

### Appendix 2

The observation optical system according to Appendix 1,
in which the surface of the objective lens on the eyepoint side includes a region that has a concave surface facing the eyepoint side in a paraxial region and has the negative refractive power which decreases away from the optical axis.

### Appendix 3

The observation optical system according to Appendix 1 or 2,
in which the surface of the eyepiece lens on the eyepoint side includes a region that has a convex surface facing the eyepoint side in a paraxial region and has the positive refractive power which increases away from the optical axis.

### Appendix 4

The observation optical system according to any one of Appendices 1 to 3,
in which Conditional Expression (1-1) is satisfied, which is represented by

$$1.8 < ( R 4 - R 2 ) / ( R 4 + R 2 ) < 3.5 . \qquad ( 1 - 1 )$$

### Appendix 5

The observation optical system according to any one of Appendices 1 to 3,
in which Conditional Expression (1-2) is satisfied, which is represented by 1.85<(R4−R2)/(R4+R2)<3 (1-2).

$$1.85 < ( R 4 - R 2 ) / ( R 4 + R 2 ) < 3. \qquad ( 1 - 2 )$$

### Appendix 6

The observation optical system according to any one of Appendices 1 to 3,
in which Conditional Expression (1-3) is satisfied, which is represented by

$$1.9 < ( R 4 - R 2 ) / ( R 4 + R 2 ) < 2.7 . \qquad ( 1 - 3 )$$

### Appendix 7

The observation optical system according to any one of Appendices 1 to 6,
in which Conditional Expression (2-1) is satisfied, which is represented by

$$55 < D sum / ( \vert f 1 \vert / f 2 ) < 78. \qquad ( 2 - 1 )$$

### Appendix 8

The observation optical system according to any one of Appendices 1 to 6,
in which Conditional Expression (2-2) is satisfied, which is represented by

$$60 < D sum / ( \vert f 1 \vert / f 2 ) < 75. \qquad ( 2 - 2 )$$

### Appendix 9

The observation optical system according to any one of Appendices 1 to 6,
in which Conditional Expression (2-3) is satisfied, which is represented by

$$61.5 < D sum / ( \vert f 1 \vert / f 2 ) < 74. \qquad ( 2 - 3 )$$

### Appendix 10

The observation optical system according to any one of Appendices 1 to 9,
in which Conditional Expression (3-1) is satisfied, which is represented by

$$1.46 < Nave < 1.6 . \qquad ( 3 - 1 )$$

### Appendix 11

The observation optical system according to any one of Appendices 1 to 9,
in which Conditional Expression (3-2) is satisfied, which is represented by

$$1.47 < Nave < 1.58 . \qquad ( 3 - 2 )$$

### Appendix 12

The observation optical system according to any one of Appendices 1 to 9,
in which Conditional Expression (3-3) is satisfied, which is represented by

$$1.475 < Nave < 1.56 . \qquad ( 3 - 3 )$$

### Appendix 13

The observation optical system according to any one of Appendices 1 to 12,
in which Conditional Expression (4-1) is satisfied, which is represented by

$$0.105 < D 2 / Dsum < 0.26 . \qquad ( 4 - 1 )$$

### Appendix 14

The observation optical system according to any one of Appendices 1 to 12,
in which Conditional Expression (4-2) is satisfied, which is represented by

$$0.11 < D 2 / Dsum < 0.24 . \qquad ( 4 - 2 )$$

### Appendix 15

The observation optical system according to any one of Appendices 1 to 12, in which Conditional Expression (4-3) is satisfied, which is represented by

$$0.115 < D 2 / Dsum < 0.22 . \qquad ( 4 - 3 )$$

### Appendix 16

The observation optical system according to any one of Appendices 1 to 15,
in which, in a case where a refractive index of the objective lens on the d line is denoted by N1, and
an Abbe number of the objective lens based on the d line is denoted by ν1,
Conditional Expression (5) is satisfied, which is represented by

$$1. 8 < N 1 + 0.01 \times ν1 < 2.14 . \qquad ( 5 )$$

### Appendix 17

The observation optical system according to any one of Appendices 1 to 16,
in which, in a case where a refractive index of the eyepiece lens on the d line is denoted by N2, and
an Abbe number of the eyepiece lens based on the d line is denoted by ν2,
Conditional Expression (6) is satisfied, which is represented by

$$1. 8 < N 2 + 0.01 \times ν2 < 2.14 . \qquad ( 6 )$$

### Appendix 18

The observation optical system according to any one of Appendices 1 to 17,
in which Conditional Expression (7) is satisfied, which is represented by

$$1 < f 2 / Dsum < 2. \qquad ( 7 )$$

### Appendix 19

The observation optical system according to any one of Appendices 1 to 18,
in which, in a case where an air conversion length on the optical axis from the surface of the objective lens on the eyepoint side to a surface of the eyepiece lens on the object side is denoted by D12,
Conditional Expression (8) is satisfied, which is represented by

$$0.05 < R 2 / D 12 < 1. \qquad ( 8 )$$

### Appendix 20

An optical apparatus comprising the observation optical system according to any one of Appendices 1 to 19.

What is claimed is:

1. An observation optical system consisting of, in order from an object side to an eyepoint side, two lenses including an objective lens having a negative refractive power and an eyepiece lens having a positive refractive power, wherein, in a case where:
a paraxial curvature radius of a surface of the eyepiece lens on the eyepoint side is denoted by R4,
a paraxial curvature radius of a surface of the objective lens on the eyepoint side is denoted by R2,
a distance from an intersection between a surface of the objective lens on the object side and an optical axis to an intersection between the surface of the eyepiece lens on the eyepoint side and the optical axis is denoted by Dsum,
a focal length of the objective lens is denoted by f1,
a focal length of the eyepiece lens is denoted by f2,
an average value of refractive indices of all lenses included in the observation optical system on a d line is denoted by Nave, and
a center thickness of the eyepiece lens is denoted by D2,
Conditional Expressions (1), (2), (3), and (4) are satisfied:
$$1.7 < ( R 4 - R 2 ) / ( R 4 + R 2 ) < 4 , \qquad ( 1 )$$
$$50 < Dsum / ( \vert f 1 \vert / f 2 ) < 80 , \qquad ( 2 )$$
$$1.45 < Nave < 1.65 , and \qquad ( 3 )$$
$$0.1 < D 2 / Dsum < 0.3 . \qquad ( 4 )$$

2. The observation optical system according to claim 1, wherein the surface of the objective lens on the eyepoint side includes a region that has a concave surface facing the eyepoint side in a paraxial region and has the negative refractive power which decreases away from the optical axis.

3. The observation optical system according to claim 1, wherein the surface of the eyepiece lens on the eyepoint side includes a region that has a convex surface facing the eyepoint side in a paraxial region and has the positive refractive power which increases away from the optical axis.

4. The observation optical system according to claim 1, wherein Conditional Expression (1-1) is satisfied:
$$1.8 < ( R 4 - R 2 ) / ( R 4 + R 2 ) < 3.5 . \qquad ( 1 - 1 )$$

5. The observation optical system according to claim 1, wherein Conditional Expression (1-2) is satisfied:
$$1.85 < ( R 4 - R 2 ) / ( R 4 + R 2 ) < 3. \qquad ( 1 - 2 )$$

6. The observation optical system according to claim 1, wherein Conditional Expression (1-3) is satisfied:
$$1.9 < ( R 4 - R 2 ) / ( R 4 + R 2 ) < 2.7 . \qquad ( 1 - 3 )$$

7. The observation optical system according to claim 1, wherein Conditional Expression (2-1) is satisfied:
$$55 < Dsum / ( \vert f 1 \vert / f 2 ) < 78. \qquad ( 2 - 1 )$$

8. The observation optical system according to claim 1, wherein Conditional Expression (2-2) is satisfied:
$$60 < Dsum / ( \vert f 1 \vert / f 2 ) < 75. \qquad ( 2 - 2 )$$

9. The observation optical system according to claim 1, wherein Conditional Expression (2-3) is satisfied:
$$61.5 < Dsum / ( \vert f 1 \vert / f 2 ) < 74. \qquad ( 2 - 3 )$$

10. The observation optical system according to claim 1, wherein Conditional Expression (3-1) is satisfied:
$$1.46 < Nave < 1.6 . \qquad ( 3 - 1 )$$

11. The observation optical system according to claim 1, wherein Conditional Expression (3-2) is satisfied:
$$1.47 < N ave < 1 \text{.58} . \qquad ( 3 - 2 )$$

12. The observation optical system according to claim 1, wherein Conditional Expression (3-3) is satisfied:
$$1.475 < N ave < 1.56 . \qquad ( 3 - 3 )$$

13. The observation optical system according to claim 1, wherein Conditional Expression (4-1) is satisfied:
$$0.105 < D 2 / D sum < 0 \text{.26} . \qquad ( 4 - 1 )$$

14. The observation optical system according to claim 1, wherein Conditional Expression (4-2) is satisfied:
$$0.11 < D 2 / D sum < 0.24 . \qquad ( 4 - 2 )$$

15. The observation optical system according to claim 1, wherein Conditional Expression (4-3) is satisfied:
$$0.115 < D 2 / D sum < 0.22 . \qquad ( 4 - 3 )$$

16. The observation optical system according to claim 1, wherein, in a case where:
a refractive index of the objective lens on the d line is denoted by N1, and
an Abbe number of the objective lens based on the d line is denoted by ν1,
Conditional Expression (5) is satisfied:
$$1.8 < N 1 + 0.01 \times v 1 < 2 \text{.14} . \qquad ( 5 )$$

17. The observation optical system according to claim 1, wherein, in a case where:
a refractive index of the eyepiece lens on the d line is denoted by N2, and
an Abbe number of the eyepiece lens based on the d line is denoted by ν2,
Conditional Expression (6) is satisfied:
$$1.8 < N 2 + 0.01 \times v 2 < 2 \text{.14} . \qquad ( 6 )$$

18. The observation optical system according to claim 1, wherein Conditional Expression (7) is satisfied:
$$1 < f 2 / D sum < 2. \qquad ( 7 )$$

19. The observation optical system according to claim 1, wherein, in a case where:
an air conversion length on the optical axis from the surface of the objective lens on the eyepoint side to a surface of the eyepiece lens on the object side is denoted by D12,
Conditional Expression (8) is satisfied:
$$0.05 < R 2 / D 12 < 1. \qquad ( 8 )$$

20. An optical apparatus comprising: the observation optical system according to claim 1.
